(19) United States
(12) Patent Application Publication
(10) Pub. No.: US 2025/0290809 A1
(43) Pub. Date: Sep. 18, 2025

(54) DETECTION DEVICE

(71) Applicant: Japan Display Inc., Tokyo (JP)

(72) Inventor: Hitoshi TANAKA, Tokyo (JP)

(21) Appl. No.: 19/077,264

(22) Filed: Mar. 12, 2025

(30) Foreign Application Priority Data
Mar. 14, 2024 (JP) 2024-040072

(51) Int. Cl. G01L 1/20

(52) U.S. Cl. CPC G01L 1/205

(57) ABSTRACT

According to an aspect, a detection device includes a first substrate having a first surface, a sensor layer facing the first surface, and spacers forming a gap between the first surface and the sensor layer. The first substrate is provided with a detection electrode, a common electrode, a transistor, a gate line coupled to a gate electrode of the transistor, a signal line coupled to a source electrode or a drain electrode of the transistor, a reference potential line, and first and second contact holes. Part of the detection electrode is disposed in the first contact hole and serves as a first contact portion coupled to the other of the source and drain electrodes. Part of the common electrode is disposed in the second contact hole and serves as a second contact portion coupled to the reference potential line. The spacers are formed on the first and second contact portions.

### CROSS-REFERENCE TO RELATED APPLICATION

This application claims the benefit of priority from Japanese Patent Application No. 2024-040072 filed on Mar. 14, 2024, the entire contents of which are incorporated herein by reference.

### BACKGROUND

### 1. Technical Field

What is disclosed herein relates to a detection device.

### 2. Description of the Related Art

A detection device herein is a device that detects force. The detection device includes a common electrode, detection electrodes, and a sensor layer in contact with the common electrode and the detection electrodes. As described in Japanese Patent Application Laid-open Publication No. 2018-146489, the sensor layer includes a body made of rubber, for example, and a plurality of conductive particles dispersed in the body. When force is applied to the sensor layer, the body deforms, and the conductive particles come into contact with each other. As a result, the resistance of the sensor layer decreases, and a current flows from the common electrode to the detection electrodes via the sensor layer.

When the application of force is released, the body of the sensor layer returns to its original shape. However, it takes time for the body to return to its original shape. In other words, some of the conductive particles remain in contact with each other until the body returns to its original shape, and the resistance of the sensor layer does not increase quickly. As a result, a current flows to the detection electrodes via the sensor layer immediately after the application of force is released. For this reason, it is desired that the detection electrodes quickly detect that no force is applied when the application of force is released.

### SUMMARY

According to an aspect, a detection device includes: a first substrate having a first surface formed of an organic insulating layer; a sensor layer facing the first surface; and a plurality of spacers disposed between the first substrate and the sensor layer and forming a gap between the first surface and the sensor layer. The first substrate is provided with: a detection electrode provided on the first surface; a common electrode provided on the first surface and disposed around the detection electrode; a transistor covered by the organic insulating layer; a gate line covered by the organic insulating layer and coupled to a gate electrode of the transistor; a signal line covered by the organic insulating layer and coupled to one of a source electrode and a drain electrode of the transistor; a reference potential line covered by the organic insulating layer; and a first contact hole and a second contact hole formed on the first surface. Part of the detection electrode is disposed in the first contact hole and serves as a first contact portion coupled to the other of the source electrode and the drain electrode of the transistor. Part of the common electrode is disposed in the second contact hole and serves as a second contact portion coupled to the reference potential line. The spacers are respectively formed on the first contact portion and the second contact portion.

According to an aspect, a detection device includes: a first substrate having a first surface formed of an organic insulating layer; a sensor layer facing the first surface; a common electrode disposed at a side opposite to the first substrate when viewed from the sensor layer; and a spacer disposed between the first substrate and the sensor layer and forming a gap between the first surface and the sensor layer. The first substrate is provided with: a detection electrode provided on the first surface; a transistor covered by the organic insulating layer; a gate line covered by the organic insulating layer and coupled to a gate electrode of the transistor; a signal line covered by the organic insulating layer and coupled to one of a source electrode and a drain electrode of the transistor; and a contact hole formed on the first surface. Part of the detection electrode is disposed in the contact hole and serves as a contact portion coupled to the other of the source electrode and the drain electrode of the transistor. The spacer is formed on the contact portion.

### BRIEF DESCRIPTION OF THE DRAWINGS

FIG. 1 is a perspective view schematically illustrating a detection device according to a first embodiment;

FIG. 2 is a schematic of a section of the detection device according to the first embodiment, and more specifically a schematic sectional view along line II-II of FIG. 3;

FIG. 3 is an enlarged view of part of a first surface of a first substrate according to the first embodiment viewed from a sensor layer;

FIG. 4 is a circuit diagram of a circuit configuration of the detection device according to the first embodiment;

FIG. 5 is a sectional view schematically illustrating a state where force is applied to the detection device according to the first embodiment;

FIG. 6 is a sectional view schematically illustrating a state immediately after the force applied to the detection device according to the first embodiment is released;

FIG. 7 is an enlarged view of two individual detection regions arranged on the first surface of the first substrate according to the first embodiment;

FIG. 8 is a schematic sectional view of the detection device according to a second embodiment; and

FIG. 9 is an enlarged view of part of the first surface of the first substrate according to the second embodiment viewed from the sensor layer.

### DETAILED DESCRIPTION

Exemplary aspects (embodiments) to embody a detection device according to the present disclosure are described below in greater detail with reference to the accompanying drawings. The contents described in the embodiments are not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the present disclosure and easily conceivable by those skilled in the art naturally fall within the scope of the present disclosure. To simplify the explanation, the drawings may possibly illustrate the width, the thickness, the shape, and other elements of each unit more schematically than those in the actual aspect. These elements, however, are given by way of example only and are not intended to limit interpretation of the present disclosure. In the present specification and the drawings, components similar to those previously described with reference to previous drawings are denoted by the same reference numerals, and detailed explanation thereof may be appropriately omitted.

To describe an aspect regarding a certain structure on which or above which another structure is disposed in the present specification and the claims, when “on” is simply used, it indicates both the following cases unless otherwise noted: a case where the other structure is disposed directly on and in contact with the certain structure, and a case where the other structure is disposed above the certain structure with yet another structure interposed therebetween.

### First Embodiment

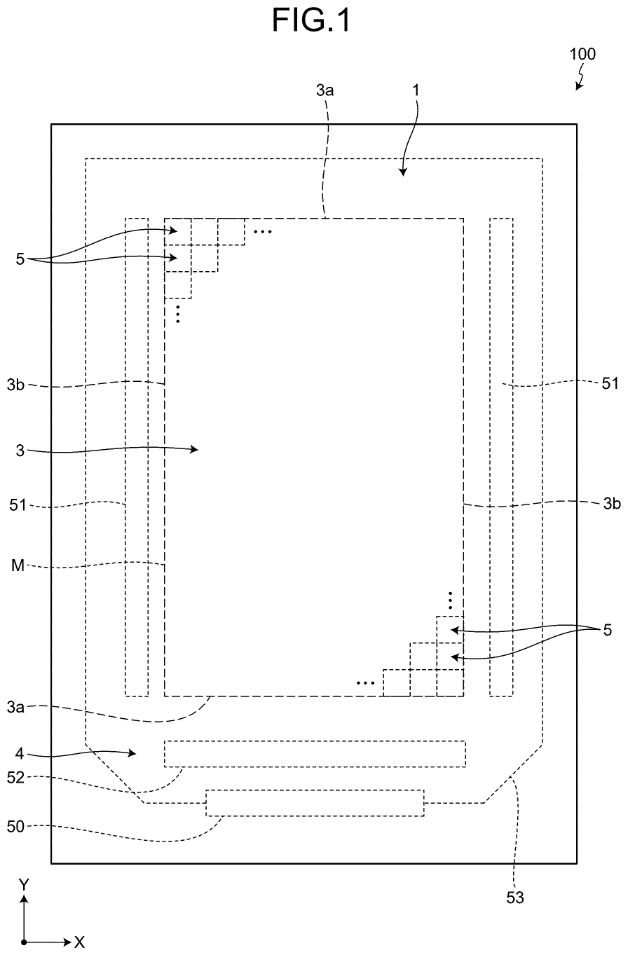

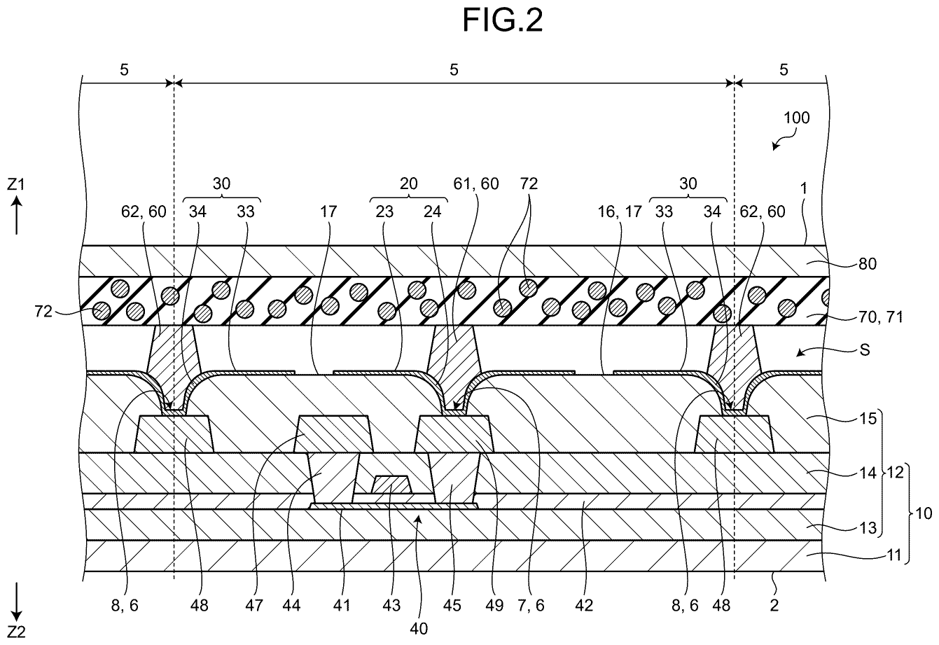

FIG. 1 is a perspective view schematically illustrating a detection device according to a first embodiment. A detection device 100 is a device that detects force acting on a detection surface 1. As illustrated in FIG. 1, the detection device 100 is formed in a flat plate shape. The detection device 100 has a flat front surface (detection surface 1) and a flat back surface 2 (not illustrated in FIG. 1, and refer to FIG. 2). The detection device 100 has a rectangular shape when viewed in the direction normal to the detection surface 1.

The detection surface 1 is divided into a detection region 3 in which force can be detected and a peripheral region 4 in which force cannot be detected. The detection region 3 is positioned at the center of the detection surface 1. The peripheral region 4 is formed in a frame shape and surrounds the outer periphery of the detection region 3.

The detection region 3 is formed in a rectangular shape when viewed in the direction normal to the detection surface 1. Therefore, an outer frame M of the detection region 3 has a pair of short sides 3a and a pair of long sides 3b. In the following description, the direction parallel to the detection surface 1 and parallel to the short side 3a is referred to as a first direction X. The direction parallel to the detection surface 1 and parallel to the long side 3b is referred to as a second direction Y. Thus, the second direction Y is a direction orthogonal to (intersecting) the first direction X. The direction parallel to the detection surface 1 may be hereinafter referred to as a planar direction.

The detection region 3 is divided into a plurality of individual detection regions 5. In other words, the detection region 3 is composed of the individual detection regions 5, and force values are detected in the respective individual detection regions 5. When viewed in the direction normal to the detection surface 1, the individual detection region 5 has a square shape. The individual detection regions 5 are arrayed in the first direction X and the second direction Y.

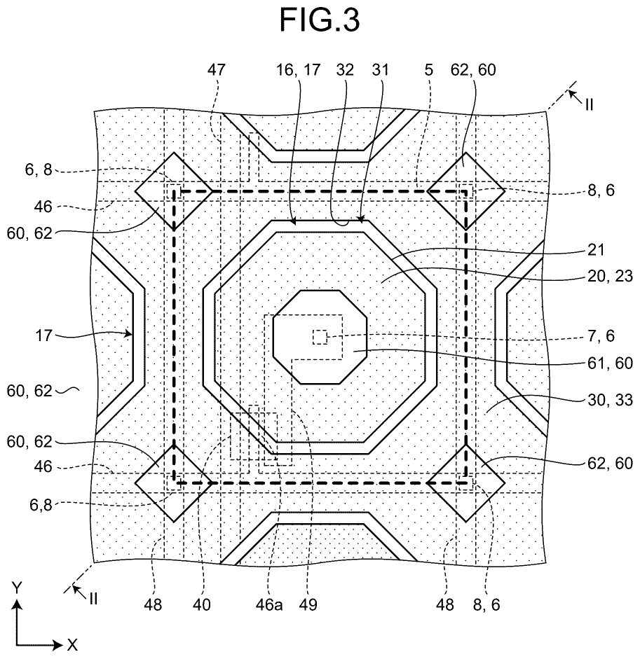

FIG. 2 is a schematic of a section of the detection device according to the first embodiment, and more specifically a schematic sectional view along line II-II of FIG. 3. As illustrated in FIG. 2, the detection device 100 includes a first substrate 10, spacers 60, a sensor layer 70, and a protective layer 80 stacked in this order. In the following description, the direction in which the first substrate 10, the spacers 60, the sensor layer 70, and the protective layer 80 are stacked is referred to as a stacking direction. The direction normal to the detection surface 1 described above is the same meaning as the stacking direction. A direction from the first substrate 10 toward the sensor layer 70 along the stacking direction is referred to as a first stacking direction Z1, and a direction opposite thereto is referred to as a second stacking direction Z2. Viewing in the first stacking direction Z1 may be referred to as plan view.

The first substrate 10 has a base 11 and a circuit formation layer 12 that is formed on a side of the base 11 in the first stacking direction Z1. The base 11 is a plate-like member that supports the circuit formation layer 12 and has an insulating property. The material of the base 11 is not particularly limited. The base 11 may be a flexible substrate made of polyimide, for example. The surface of the base 11 facing in the second stacking direction Z2 serves as the back surface 2 of the detection device 100.

The circuit formation layer 12 includes a first insulating layer 13, a second insulating layer 14, and a third insulating layer 15 stacked in this order on the surface of the base 11 facing in the first stacking direction Z1. The space between the first insulating layer 13 and the second insulating layer 14 is provided with a gate insulating film 42 of a transistor 40, which will be described later.

The first insulating layer 13 and the second insulating layer 14 are made of inorganic material, such as SiO and SiN. The third insulating layer 15 is an organic insulating layer made of organic material. The third insulating layer 15 is a layer (planarization film) for planarizing the surface of the circuit formation layer 12 facing in the first stacking direction Z1. Therefore, a first surface 16 of the circuit formation layer 12 facing in the first stacking direction Z1 is composed of the surface of the third insulating layer 15 facing in the first stacking direction Z1.

The first surface 16 of the circuit formation layer 12 is provided with detection electrodes 20 and a common electrode 30. The detection electrode 20 and the common electrode 30 are metal films made of metal material, such as indium tin oxide (ITO), and formed on the first surface 16.

FIG. 3 is an enlarged view of part of the first surface of the first substrate according to the first embodiment viewed from the sensor layer. In FIG. 3, the detection electrode 20 and the common electrode 30 are shaded with dots to make them easier to see. As illustrated in FIG. 3, the detection electrode 20 is disposed at the center of the individual detection region 5. The detection electrode 20 has a regular octagonal shape in plan view. A plurality of detection electrodes 20 are formed on the first surface 16. In other words, each individual detection region 5 is provided with one detection electrode 20.

The common electrode 30 is a solid film formed on the first surface 16 and is disposed across a plurality of individual detection regions 5. The common electrode 30 has a plurality of openings 31 having a regular octagonal shape in plan view. Each individual detection region 5 has one opening 31. The detection electrode 20 is disposed in the opening 31. Therefore, the detection electrode 20 is surrounded by the common electrode 30.

The opening 31 is larger than the detection electrode 20. Therefore, an edge 32 of the opening 31 of the common electrode 30 is separated from an edge 21 of the detection electrode 20. In other words, the detection electrode 20 and the common electrode 30 are not electrically coupled on the first surface 16. Part of the first surface 16 between the edge 32 of the opening 31 of the common electrode 30 and the edge 21 of the detection electrode 20 is exposed. The part of the first surface 16 exposed through the opening 31 may be hereinafter referred to as a first-surface exposed portion 17. The first-surface exposed portion 17 has an annular shape (octagonal frame shape).

As illustrated in FIG. 2, the first substrate 10 has a plurality of contact holes 6 extending from the first surface 16 in the second stacking direction Z2. Each contact hole 6 is formed in a part of the first surface 16 covered by either the detection electrode 20 or the common electrode 30. Therefore, when the detection electrode 20 is formed on the first surface 16, a portion depressed in the second stacking direction Z2 is formed along the contact hole 6. Thus, the detection electrode 20 has a detection-electrode flat portion 23 and a first contact portion 24. The detection-electrode flat portion 23 extends along the first surface 16 and has a flat shape. The first contact portion 24 is depressed (recessed) in the second stacking direction Z2 along the contact hole 6.

Similarly, when the common electrode 30 is formed on the first surface 16, a portion depressed in the second stacking direction Z2 is formed along the contact hole 6. Thus, the common electrode 30 has a common-electrode flat portion 33 and a second contact portion 34. The common-electrode flat portion 33 extends along the first surface 16 and has a flat shape. The second contact portion 34 is depressed (recessed) in the second stacking direction Z2 along the contact hole 6. In the following description, among the contact holes 6, the hole provided with the first contact portion 24 is referred to as a first contact hole 7, and the hole provided with the second contact portion 34 is referred to as a second contact hole 8.

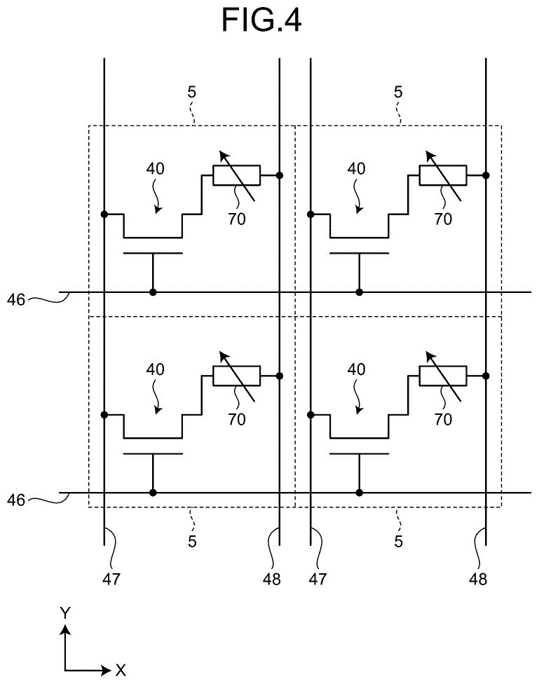

FIG. 4 is a circuit diagram of a circuit configuration of the detection device according to the first embodiment. As illustrated in FIG. 4, the circuit formation layer 12 is provided with the transistor 40, a gate line 46, a signal line 47, a reference potential line 48, a coupling section 50 (refer to FIG. 1), a gate line drive circuit 51 (refer to FIG. 1), a signal line selection circuit 52 (refer to FIG. 1), and a common line 53 (refer to FIG. 1). A plurality of the transistors 40, a plurality of the gate lines 46, a plurality of the signal lines 47, and a plurality of the reference potential lines 48 are formed in the circuit formation layer 12 (first substrate 10).

The transistor 40 is a switching element. The transistors 40 are provided to the respective individual detection regions 5. As illustrated in FIG. 2, the transistor 40 includes a semiconductor layer 41, the gate insulating film 42, a gate electrode 43, a drain electrode 44, and a source electrode 45. The end of the source electrode 45 in the first stacking direction Z1 is coupled to a coupling line 49. The coupling line 49 extends in the planar direction (refer to FIG. 3) and is coupled to the first contact portion 24 of the detection electrode 20.

As illustrated in FIG. 4, each of the gate lines 46 extends in the first direction X. The gate lines 46 are arrayed in the second direction Y. As illustrated in FIG. 3, the gate line 46 is provided with a branch 46a extending in the second direction Y. The branch 46a is provided to each individual detection region 5. The gate line 46 is coupled to the gate electrodes 43 (refer to FIG. 2) of the respective transistors 40 arrayed in the first direction X via the branches 46a.

As illustrated in FIG. 4, each of the signal lines 47 extends in the second direction Y. The signal lines 47 are arrayed in the first direction X. The signal line 47 is coupled to the drain electrodes 44 (refer to FIG. 2) of the respective transistors 40 arrayed in the second direction Y.

As illustrated in FIG. 4, each of the reference potential lines 48 extends in the second direction Y. The reference potential lines 48 are arrayed in the first direction X. As illustrated in FIG. 2, the reference potential line 48 is coupled to the second contact portion 34 of the common electrode 30.

As illustrated in FIG. 1, the coupling section 50, the gate line drive circuit 51, the signal line selection circuit 52, and the common line 53 are disposed in the peripheral region 4 in the circuit formation layer 12. The coupling section 50 couples the detection device 100 to a drive integrated circuit (IC) disposed outside the detection device 100. The drive IC may be mounted as a chip on film (COF) on a flexible printed circuit board or a rigid circuit board coupled to the coupling section 50. Alternatively, the drive IC may be mounted as a chip on glass (COG) in the peripheral region 4 of the first substrate 10.

The gate line drive circuits 51 are a circuit that drives the gate lines 46 (refer to FIG. 4) based on various control signals from the drive IC. The gate line drive circuits 51 sequentially or simultaneously select the gate lines 46 and supply gate drive signals to the selected gate lines 46.

The signal line selection circuit 52 is a switch circuit that sequentially or simultaneously selects the signal lines 47 (refer to FIG. 4). The signal line selection circuit 52 is a multiplexer, for example. The signal line selection circuit 52 couples the selected signal lines 47 to the drive IC based on selection signal supplied from the drive IC.

The common line 53 is coupled to the drive IC via the coupling section 50 and is supplied with a certain amount of current from the drive IC. The common line 53 extends along the peripheral region 4 and has an annular (frame-like) shape. The common line 53 is coupled to the reference potential lines 48. Therefore, the common electrode 30 is supplied with a certain amount of current.

As illustrated in FIG. 2, the spacer 60 is a pillar protruding from the first substrate 10 in the first stacking direction Z1. The spacer 60 according to the present embodiment is made of organic material and has an insulating property. The spacer according to the present disclosure simply needs to have an insulating property and is not necessarily made of organic material. The spacer 60 separates the first substrate 10 and the sensor layer 70 from each other in the stacking direction. In other words, a gap (space) S is formed between the first substrate 10 and the sensor layer 70. The gap S according to the present embodiment is filled with air. Thus, the gap S according to the present embodiment is an air gap.

The plurality of spacers 60 are formed. The spacers 60 include a first spacer 61 formed on the surface of the detection electrode 20 in the first stacking direction Z1 and a second spacer 62 formed on the surface of the common electrode 30 in the first stacking direction Z1.

The first spacer 61 overlaps the first contact hole 7 in plan view. In other words, the first spacer 61 is formed only on the first contact portion 24. In other words, the first spacer 61 is not formed on the detection-electrode flat portion 23 in the detection electrode 20.

The second spacer 62 overlaps the second contact hole 8 in plan view. In other words, the second spacer 62 is formed only on the second contact portion 34. In other words, the second spacer 62 is not formed on the common- electrode flat portion 33 in the common electrode 30.

As illustrated in FIG. 2, the sensor layer 70 includes a body 71 and conductive microparticles (hereinafter referred to as conductive particles 72) dispersed in the body 71. The body 71 is made of deformable and highly insulating material, such as silicone rubber. The conductive particles 72 are separated from each other in the body 71. When no force is applied to the sensor layer 70, and the body 71 is not deformed, the resistance of the sensor layer 70 is high. By contrast, when force is applied to the sensor layer 70, and the body 71 is deformed, the conductive particles 72 come into contact with or into proximity to each other, and the resistance of the sensor layer 70 decreases. The size of the sensor layer 70 is large enough to cover at least the entire detection region 3. The sensor layer 70 according to the present disclosure may or may not be bonded to the ends of the spacers 60 in the first stacking direction Z1.

The protective layer 80 is made of elastically deformable insulating material, such as rubber and resin. The surface of the protective layer 80 in the first stacking direction Z1 serves as the detection surface 1. The sensor layer 70 is bonded to the surface of the protective layer 80 in the second stacking direction Z2. The sensor layer 70 and the protective layer 80 integrally formed are bonded to and integrated with the first substrate 10 with a frame portion (not illustrated) interposed therebetween in the area overlapping the peripheral region 4.

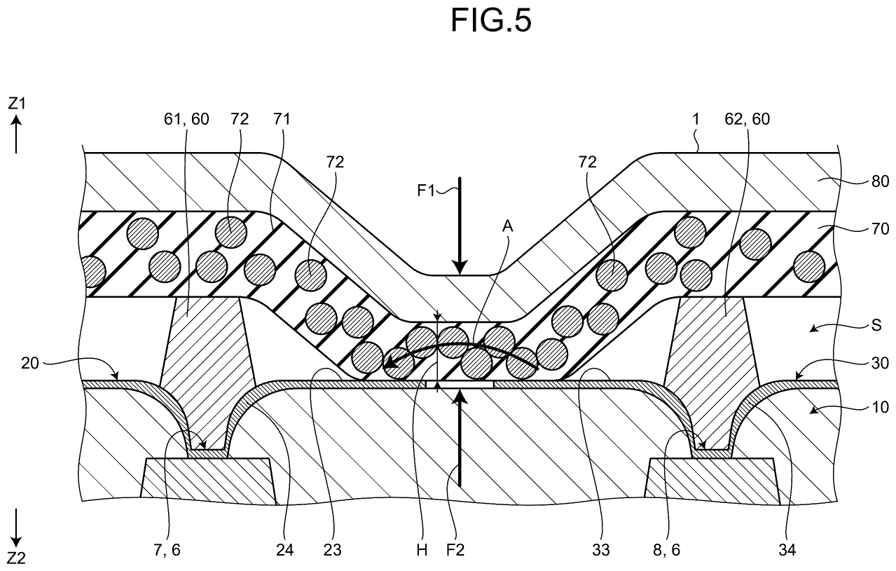

FIG. 5 is a sectional view schematically illustrating a state where force is applied to the detection device according to the first embodiment. Next, an example of the operations of the detection device 100 is described. As illustrated in FIG. 5, when force F1 is applied to the detection surface 1, the protective layer 80 and the sensor layer 70 in the individual detection region 5 to which the force F1 is applied, deform in the second stacking direction Z2. The sensor layer 70 comes into contact with the detection electrode 20 and the common electrode 30.

As a result, the sensor layer 70 is subjected to reaction force F2 from the detection electrode 20 and the common electrode 30 with which the sensor layer 70 is in contact. In other words, a compressive load due to the force F1 and the reaction force F2 acts on the sensor layer 70. Therefore, the thickness H of the body 71 of the sensor layer 70 in the stacking direction decreases. As a result, a great number of conductive particles 72 come into contact with or into proximity to each other, and the resistance of the sensor layer 70 decreases. Then, a current flows from the common electrode 30 to the detection electrode 20 via the sensor layer 70 (refer to arrow A in FIG. 5).

As the amount of deformation of the body 71 increases, the number of conductive particles 72 in contact with or in proximity to each other increases, and the resistance of the sensor layer 70 is further reduced. Therefore, the amount of electric current flowing to the detection electrode 20 increases. Thus, the current value input to the detection electrode 20 increases in proportion to the input force. The electrical signal (current value) input to the detection electrode 20 is output by the signal line 47. Based on the magnitude of the current value, the load input to the individual detection region 5 is derived. The current value input to the detection electrode 20 according to the present embodiment is proportional to the magnitude of the applied force. For example, the current value input to the detection electrode 20 may increase as the applied force increases, and the present disclosure is not limited to the example described in the embodiment.

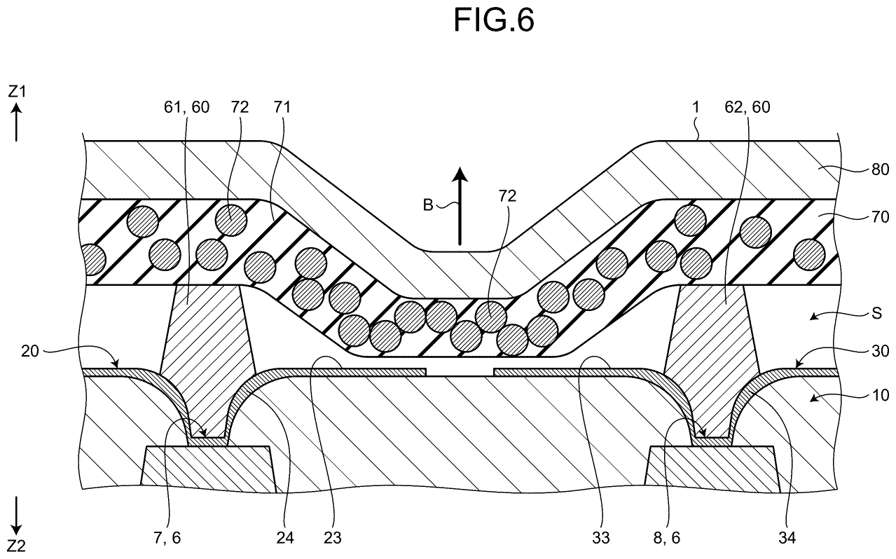

FIG. 6 is a sectional view schematically illustrating a state immediately after the force applied to the detection device according to the first embodiment is released. As illustrated in FIG. 6, when the application of the force F1 is released, the sensor layer 70 and the protective layer 80 return to their original shapes. In other words, the part of the sensor layer 70 in contact with the detection electrode 20 and the common electrode 30 moves in the first stacking direction Z1 (refer to arrow B in FIG. 6), and the thickness H of the body 71 in the stacking direction returns to its original thickness.

It takes time for the thickness H of the body 71 to return to its original thickness. This is because it takes time for the stress acting on the body 71 to be eliminated. Therefore, immediately after the application of the force F1 is released, a great number of conductive particles 72 are still in contact with or in proximity to each other, and the resistance of the sensor layer 70 has not returned to its original value (high resistance) yet. As a result, if the sensor layer 70 is in contact with the detection electrode 20 and the common electrode 30 immediately after the application of the force F1 is released, a current flows to the detection electrode 20, and the force F1 is detected.

By contrast, when the application of the force F1 is released, the sensor layer 70 according to the present embodiment moves in the first stacking direction Z1. In other words, when the application of the force F1 is released, the sensor layer 70 breaks the electrical coupling between the detection electrode 20 and the common electrode 30. Therefore, no current flows to the detection electrode 20, and the force F1 is not detected.

As described above, the detection device 100 according to the present embodiment breaks the electrical coupling between the detection electrode 20 and the common electrode 30 (contact of the sensor layer 70 with the detection electrode 20 and the common electrode 30) before the resistance of the sensor layer 70 returns to its original value. Therefore, the detection electrode 20 more quickly (earlier) detects that no force is applied than in a detection device in which the gap S is not formed (detection device in which the sensor layer is always in contact with the common electrode and the detection electrode).

The spacers 60 (the first spacer 61 and the second spacer 62) according to the present embodiment are formed overlapping the first contact portion 24 and the second contact portion 34, respectively. The first contact portion 24 (or the second contact portion 34) has a recessed shape and is less likely to come into contact with the sensor layer 70. If the sensor layer 70 comes into contact with the first contact portion 24 (or the second contact portion 34), the sensor layer 70 may possibly not deform as it does when it comes into contact with the detection-electrode flat portion 23. In other words, the first contact portion 24 of the detection electrode 20 is a region where force cannot be accurately detected, and the detection-electrode flat portion 23 is a region that is more useful. Similarly, the second contact portion 34 of the common electrode 30 is a region where force cannot be accurately detected, and the common-electrode flat portion 33 is a region that is more useful.

As described above, neither the detection-electrode flat portion 23 nor the common-electrode flat portion 33 according to the present embodiment is provided with the first spacer 61 or the second spacer 62. Therefore, the region size (area) of the detection-electrode flat portion 23 and the common-electrode flat portion 33 that can come into contact with the sensor layer 70 is secured to be large. The first spacer 61 or the second spacer 62 is formed on the first contact portion 24 and the second contact portion 34 to avoid contact of the sensor layer 70. In other words, force is detected with high accuracy.

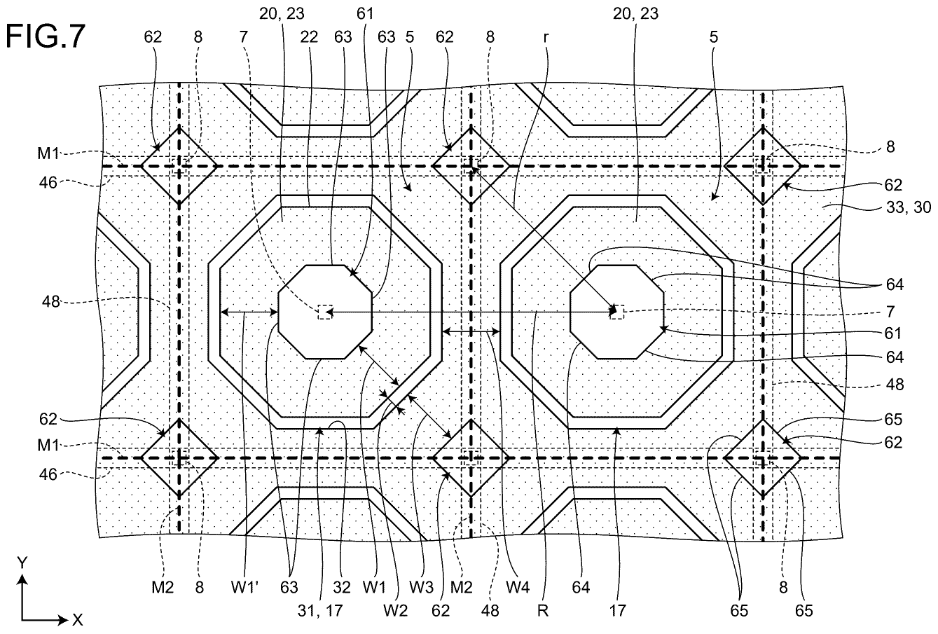

FIG. 7 is an enlarged view of two individual detection regions arranged on the first surface of the first substrate according to the first embodiment. In FIG. 7, part of the configuration of the first substrate 10 is not illustrated. Next, the detection device 100 is described in greater detail. The first contact hole 7 is formed at the center of the individual detection region 5 in plan view. Therefore, the first spacer 61 is also disposed at the center of the individual detection region 5.

The boundary line that partitions the detection region 3 into the individual detection regions 5 in the second direction Y, is referred to as a first boundary line M1. The boundary line that partitions the detection region 3 into the individual detection regions 5 in the first direction X, is referred to as a second boundary line M2. The gate line 46 overlaps the first boundary line M1 in plan view. The reference potential line 48 overlaps the second boundary line M2 in plan view.

The second contact hole 8 is formed at the part where the gate line 46 and the reference potential line 48 overlap in plan view. In other words, the second contact holes 8 and the second spacers 62 are formed at the four corners of the individual detection region 5. Therefore, the second spacers 62 are provided at the farthest portions from the first spacer 61 in the individual detection region 5. The distances between the central axis of one first spacer 61 and the respective central axes of the four second spacers 62 are equal.

When the distance between the central axis of the first spacer 61 and the central axis of the second spacer 62 is r, the distance R between the central axes of the first spacers 61 adjacent to each other in the first direction X or the second direction Y is √2×r (R=√2×r). Thus, the distance r between the central axis of one first spacer 61 and the central axis of the second spacer 62 is different from the distance R between the central axis of the one first spacer 61 and the central axis of another first spacer 61 adjacent to the one first spacer 61.

The first spacer 61 has a regular octagonal shape in plan view. In other words, the side surfaces of the first spacer 61 have four first facing surfaces 63 and four second facing surfaces 64. The four first facing surfaces 63 extend along the first direction X or the second direction Y. The four second facing surfaces 64 extend along a direction (diagonal direction) of 45° with respect to the first direction X (or the second direction Y). The first facing surface 63 faces the first spacer 61 in the individual detection region 5 arranged next to the first facing surface 63. The second facing surface 64 faces the second spacer 62 disposed at the corner of the individual detection region 5.

The second spacer 62 has a square shape in plan view. The side surfaces of the second spacer 62 are composed of four facing surfaces 65 extending along a direction (diagonal direction) of 45° with respect to the first direction X (or the second direction Y). Therefore, the facing surfaces 65 face the four first spacers 61 adjacent thereto.

In terms of the size (area) of the detection-electrode flat portion 23, the width from the second facing surface 64 of the first spacer 61 to the first-surface exposed portion 17 (edge 22 of the detection electrode 20) is W1. The width from the first facing surface 63 of the first spacer 61 to the first-surface exposed portion 17 (edge 22 of the detection electrode 20) is W1′. The width W1 and the width W1′ in the detection-electrode flat portion 23 are equal (W1=W1′). Thus, the detection-electrode flat portion 23 is rotationally symmetrical about the central axis of the first spacer 61.

In terms of the size (area) of the common-electrode flat portion 33, the width from the facing surface 65 of the second spacer 62 to the edge 32 of the opening 31 of the common electrode 30 is W3. A width W2 of the first-surface exposed portion 17 is equally formed in the circumferential direction. The first-surface exposed portion 17 is positioned at a center between the first spacer 61 and the second spacer 62 and is formed at such a position that the width W1 of the detection-electrode flat portion 23 and the width W3 of the common-electrode flat portion 33 are equal (W1=W3). Therefore, when force is applied between the first spacer 61 and the second spacer 62, the sensor layer 70 comes into contact with the detection-electrode flat portion 23 and the common-electrode flat portion 33 in a well-balanced manner.

A width W4 of the part of the common-electrode flat portion 33 arranged between the first spacers 61 is equal to the width W3.

The detection device 100 according to the first embodiment has been described above. While one common electrode 30 according to the first embodiment is disposed across the individual detection regions 5, a plurality of common electrodes 30 may be provided to the respective individual detection regions 5. Alternatively, a plurality of common electrodes 30 may be disposed such that one common electrode 30 is provided for every four individual detection regions 5, for example. While the source electrode 45 of the transistor 40 according to the embodiment is coupled to the detection electrode 20, and the drain electrode 44 is coupled to the signal line 47, the source electrode 45 according to the present disclosure may be coupled to the signal line 47, and the drain electrode 44 may be coupled to the detection electrode 20. The distance R between the first spacers 61 and the distance r between the first spacer 61 and the second spacer 62 are different from each other. In other words, the spaces (intervals) at which the spacers 60 are disposed are different. Therefore, the widths W1, W2, W3, and W4 according to the present disclosure may be modified as appropriate. The shapes of the spacers 60 in plan view may be circular or other polygonal shapes other than the octagonal and square shapes described in the embodiment.

Next, a detection device 100A according to a second embodiment is described. The following describes the second embodiment focusing on the differences from the first embodiment.

### Second Embodiment

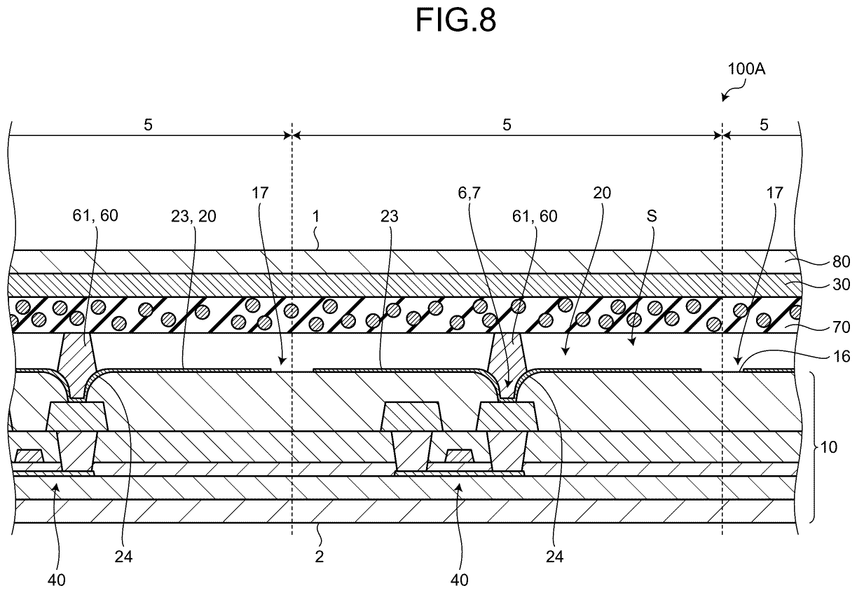

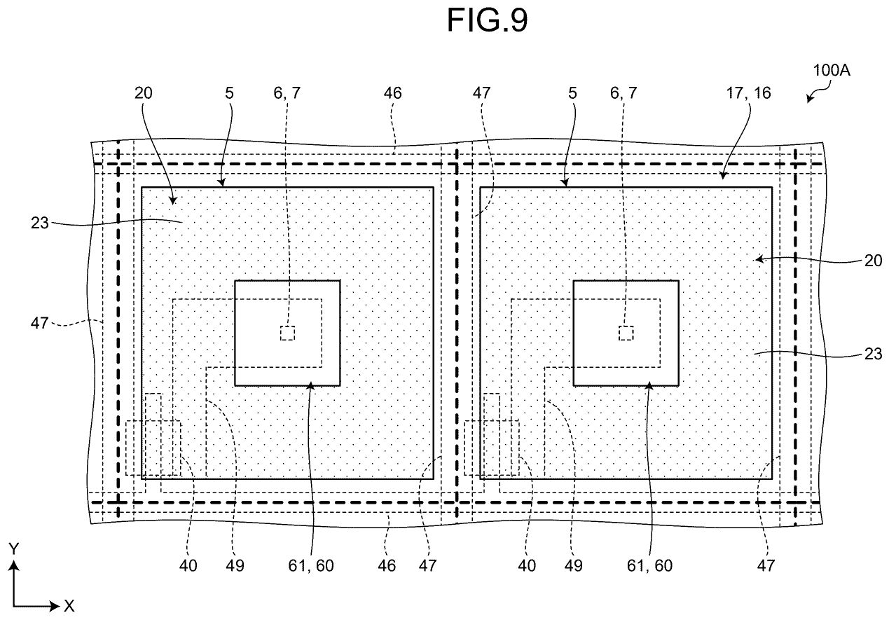

FIG. 8 is a schematic sectional view of the detection device according to the second embodiment. FIG. 9 is an enlarged view of part of the first surface of the first substrate according to the second embodiment viewed from the sensor layer. As illustrated in FIG. 8, the detection device 100A according to the second embodiment is different from the first embodiment in that the common electrode 30 is disposed between the sensor layer 70 and the protective layer 80 instead of being on the first surface 16 of the first substrate 10.

With this configuration, the first substrate 10 according to the second embodiment is different from the first embodiment in that the first substrate 10 include no reference potential line 48. The common electrode 30 is a solid film extending in the planar direction and has no opening 31. The common electrode 30 according to the second embodiment is supplied with a current from the common line 53 by another wiring line (not illustrated).

The detection device 100A according to the second embodiment is different from the first embodiment in that the detection device 100A does not include the second spacer 62 or the second contact hole 8 because the second contact portion (common electrode 30) is not provided on the first surface 16 of the first substrate 10. Therefore, the gap S according to the second embodiment is formed by a plurality of first spacers 61.

As illustrated in FIG. 9, the detection-electrode flat portion 23 of the detection electrode 20 is different from the first embodiment in that the detection-electrode flat portion 23 is formed in a square shape in plan view. The area of the detection-electrode flat portion 23 according to the second embodiment is smaller than that of the individual detection region 5. Therefore, the detection electrode 20 is separated from the detection electrodes 20 in the individual detection regions adjacent thereto. The first-surface exposed portion 17 having a grid shape is arranged between the detection electrodes 20 adjacent in the first direction X and between the detection electrodes 20 adjacent in the second direction Y.

In the detection device 100A according to the second embodiment, force is applied to the detection surface 1, and the sensor layer 70 comes into contact with the detection-electrode flat portion 23 of the detection electrode 20. A current flows from the common electrode 30 to the detection electrode 20 via the sensor layer 70. Thus, the applied force can be detected for each individual detection region 5. When the application of the force is released, the sensor layer 70 moves in the first stacking direction Z1 as in the first embodiment. As a result, no current flows to the detection electrode 20, and the force is not detected. Therefore, the detection electrode 20 according to the second embodiment also more quickly (earlier) detects that no force is applied than in a detection device in which the gap S is not formed (a detection device in which the sensor layer is always in contact with the common electrode and the detection electrode).

What is claimed is:

1. A detection device comprising:
a first substrate having a first surface formed of an organic insulating layer;
a sensor layer facing the first surface; and
a plurality of spacers disposed between the first substrate and the sensor layer and forming a gap between the first surface and the sensor layer, wherein
the first substrate is provided with:
a detection electrode provided on the first surface;
a common electrode provided on the first surface and disposed around the detection electrode;
a transistor covered by the organic insulating layer;
a gate line covered by the organic insulating layer and coupled to a gate electrode of the transistor;
a signal line covered by the organic insulating layer and coupled to one of a source electrode and a drain electrode of the transistor;
a reference potential line covered by the organic insulating layer; and
a first contact hole and a second contact hole formed on the first surface,
part of the detection electrode is disposed in the first contact hole and serves as a first contact portion coupled to the other of the source electrode and the drain electrode of the transistor,
part of the common electrode is disposed in the second contact hole and serves as a second contact portion coupled to the reference potential line, and
the spacers are respectively formed on the first contact portion and the second contact portion.

2. The detection device according to claim 1, wherein the gap is an air gap.

3. The detection device according to claim 1, wherein the spacers are made of organic material.

4. The detection device according to claim 1, wherein
the first substrate is provided with a plurality of the detection electrodes, a plurality of the transistors, a plurality of the gate lines, a plurality of the signal lines, and a plurality of the reference potential lines,
the detection electrodes are arrayed in a first direction parallel to the first surface and a second direction parallel to the first surface and intersecting the first direction,
the transistors are arrayed in the first direction and the second direction corresponding to the respective detection electrodes,
the gate lines extend in the first direction and are arrayed in the second direction,
the signal lines extend in the second direction and are arrayed in the first direction, and
the reference potential lines extend in the second direction and are arrayed in the first direction.

5. The detection device according to claim 4, wherein a plurality of the second contact holes are each formed at a part overlapping a corresponding one of the gate lines when viewed in a stacking direction in which the first substrate and the sensor layer are disposed, and the reference potential lines are coupled to the common electrode through the second contact holes, respectively.

6. The detection device according to claim 5, wherein the distances between the first contact hole and the second contact holes formed near the first contact hole are equal.

7. The detection device according to claim 1, wherein the detection electrode is surrounded by the common electrode.

8. A detection device comprising:
a first substrate having a first surface formed of an organic insulating layer;
a sensor layer facing the first surface;
a common electrode disposed at a side opposite to the first substrate when viewed from the sensor layer; and
a spacer disposed between the first substrate and the sensor layer and forming a gap between the first surface and the sensor layer, wherein
the first substrate is provided with:
a detection electrode provided on the first surface;
a transistor covered by the organic insulating layer;
a gate line covered by the organic insulating layer and coupled to a gate electrode of the transistor;
a signal line covered by the organic insulating layer and coupled to one of a source electrode and a drain electrode of the transistor; and
a contact hole formed on the first surface,
part of the detection electrode is disposed in the contact hole and serves as a contact portion coupled to the other of the source electrode and the drain electrode of the transistor, and
the spacer is formed on the contact portion.

9. The detection device according to claim 8, wherein the gap is an air gap.

10. The detection device according to claim 8, wherein the spacer is made of organic material.

11. The detection device according to claim 8, wherein
the first substrate is provided with a plurality of the detection electrodes, a plurality of the transistors, a plurality of the gate lines, and a plurality of the signal lines,
the detection electrodes are arrayed in a first direction parallel to the first surface and a second direction parallel to the first surface and intersecting the first direction,
the transistors are arrayed in the first direction and the second direction corresponding to the respective detection electrodes,
the gate lines extend in the first direction and are arrayed in the second direction, and
the signal lines extend in the second direction and are arrayed in the first direction.
